(19) United States
(12) Patent Application Publication
(10) Pub. No.: US 2017/0206992 A1
(43) Pub. Date: Jul. 20, 2017

(54) APPARATUS FOR TREATING RADIOACTIVE MATERIAL USING MULTIPLE SEPARATION MEMBRANES

(71) Applicant: Korea University Research and Business Foundation, Seoul (KR)

(72) Inventors: Seung-Kwan HONG, Yongin-si (KR); Byeong-Gyu CHOI, Gwacheon-si (KR); Song-Bok LEE, Seoul (KR)

(73) Assignee: Korea University Research and Business Foundation, Seoul (KR)

(21) Appl. No.: 15/324,025

(22) PCT Filed: Apr. 28, 2015
(86) PCT No.: PCT/KR2015/004213

§ 371 Date: Jan. 5, 2017

(30) Foreign Application Priority Data
Jul. 14, 2014 (KR) 10-2014-0088666

(51) Int. Cl. G21F 9/12; B01D 61/00; B01D 61/58; B01D 61/08; B01D 61/12; B01D 61/36; G21F 9/22; B01D 61/02

(52) U.S. Cl. CPC G21F 9/12; G21F 9/22; B01D 61/002; B01D 61/025; B01D 61/08; B01D 61/12; B01D 61/364; B01D 61/366; B01D 61/58; B01D 2311/10; B01D 2311/2673

(57) ABSTRACT

Apparatuses for treating radioactive material using a multi-membrane are disclosed. The apparatus for treating radioactive material uses a multi-membrane capable of increasing the usage capacity and life of the storage tank with a multi-membrane process by discharging liquid (e.g., water in waste water) in which radioactive material is removed from waste water to the outside and by storing solidified waste containing radioactive material in the storage tank.

### TECHNICAL FIELD

The invention relates to an apparatus for treating radioactive material using a multi-membrane and in particular, to an apparatus for treating radioactive material using a multi-membrane and in particular capable of separating radioactive material from waste water by multi-membrane process.

### BACKGROUND ART

Korean application No. 10-1999-0017129 discloses an apparatus for treating radioactive laundry waste water using a reverse osmosis membrane and UV/hydrogen-peroxide photo-oxidation and method thereof.

The conventional apparatus and method for treating radioactive laundry waste water using a reverse osmosis membrane and UV/hydrogen-peroxide photo-oxidation relates to a treatment of laundry waste water small amount of radioactive material generated from atomic power plant. In the conventional apparatus and method for treating radioactive laundry waste water using a reverse osmosis membrane and UV/hydrogen-peroxide photo-oxidation, radioactive material contained in waste water is pre-treated using UV and hydrogen-peroxide, is treated by a reverse osmosis process, and then is finally treated by passing through an ion exchange resin. Such a convention technique requires consumption goods such as hydrogen-peroxide and ion exchange resin, etc. which need to be used up continuously, thereby decreasing economical utility.

Further, in case of laundry waste water containing radioactive material, laundry waste water must be treated after the removal of radioactive material from the laundry waste water due to the progress of the half-life of radioactive material and therefore, the storage tank for storing laundry waste water must be enlarged.

### DISCLOSURE OF THE INVENTION

### Technical Problem

The invention is intended to solve the above problems and provides an apparatus for treating radioactive material using a multi-membrane, capable of increasing the usage capacity and life of the storage tank with a multi-membrane process by discharging liquid (e.g., water in waste water) in which radioactive material is removed from waste water to outside and by storing solidified waste containing radioactive material in the storage tank.

### Technical Solution

Preferably, An apparatus for treating radioactive material apparatus for treating radioactive material using a multi-membrane comprises a storage tank which stores waste water containing radioactive material; a forward osmosis processing unit which is connected to the storage tank to receive waste water from the storage tank, and which supplies waste water treated with a forward osmosis process based on a density difference from draw solution to the storage tank; and a reverse osmosis processing unit which is connected to the forward osmosis processing unit to receive dilution draw solution from the forward osmosis processing unit, the dilution draw solution being formed by mixing water filtered from the waste water during the forward osmosis process and the draw solution, which supplies recovery draw solution to the forward osmosis processing unit, the recovery draw solution being remaining water of the dilution draw solution after treating the dilution draw solution by a reverse osmosis process, and which discharges treatment water which contains water moved out from the dilution draw solution during the reverse osmosis process.

In one embodiment, the apparatus preferably further comprises a first membrane distillation processing unit which is connected to the reverse osmosis processing unit to receive the treatment water from the reverse osmosis processing unit and which generates final treatment water by treating radioactive material which still exists in the treatment water, by a first membrane distillation process.

In one embodiment, the apparatus preferably further comprises a temperature control unit connected to the reverse osmosis processing unit and the first membrane distillation processing unit, the temperature control unit being configured to control temperature of the treatment water such that the temperature of the treatment water supplied from the reverse osmosis processing unit to the first membrane distillation processing unit becomes a temperature at which the first membrane distillation process is performed, wherein the temperature control unit is connected to the first membrane distillation processing unit in a circulation structure to receive treatment water containing radioactive material from the first membrane distillation processing unit.

In one embodiment, a draw solution storage unit which stores the recovery draw solution is connected to the forward osmosis processing unit and the reverse osmosis processing unit to form a circular structure, the recovery draw solution is stored in the draw solution storage unit and then is supplied to the forward osmosis processing unit.

In one embodiment, the apparatus preferably further comprises a second membrane distillation processing unit which is arranged between the draw solution storage unit and the forward osmosis processing unit, wherein the second membrane distillation processing unit generates draw solution by treating the radioactive material which exists in the recovery draw solution stored in the draw solution storage unit by a second membrane distillation process based on a vapor pressure difference.

In one embodiment, the apparatus preferably further comprises a crystallization unit connected to the second membrane distillation processing unit and the storage tank, wherein the crystallization unit receives the recovery draw solution in which radioactive material still exits after the second membrane distillation process and then crystallizes the recovery draw solution.

In one embodiment, the apparatus preferably further comprises an evaporation unit connected to the draw solution storage unit and the storage tank, wherein the evaporation unit receives the recovery draw solution containing radioactive material from the draw solution storage unit, separates the recovery draw solution into radioactive material and draw solution by an evaporation process, and then supplies the separated radioactive material to the storage tank and supplies the separated draw solution to the reverse osmosis processing unit.

In one embodiment, the apparatus preferably further comprises a pretreatment unit connected to the storage tank and the forward osmosis processing unit, wherein the pretreatment unit separates the solid material from the waste water before the waste water in the storage tank flows into the forward osmosis processing unit, and then supplies the solid material to the storage tank and supplies waste water in which the solid material was separated to the forward osmosis processing unit.

### Advantageous Effect

According to the present invention, by means of a multi-membrane process such as a forward osmosis process, a reverse osmosis process and membrane distillation process, liquid (e.g., water in waste water) in which radioactive material is removed from waste water can be discharged to outside, and solidified waste containing radioactive material can be stored in the storage tank, thereby the usage capacity and life of the storage tank can be maximized and radioactive material can be treated more efficiently.

### BRIEF DESCRIPTION OF THE DRAWINGS

FIG. 1 schematically shows an apparatus for treating radioactive material using a multi-membrane according to the first embodiment.

FIG. 2 schematically shows an apparatus for treating radioactive material using a multi-membrane according to the second embodiment.

FIG. 3 schematically shows an apparatus for treating radioactive material using a multi-membrane according to the third embodiment.

FIG. 4 schematically shows an apparatus for treating radioactive material using a multi-membrane according to the fourth embodiment.

FIG. 5 schematically shows an apparatus for treating radioactive material using a multi-membrane according to the fifth embodiment.

FIG. 6 schematically shows an apparatus for treating radioactive material using a multi-membrane according to the sixth embodiment.

### DETAILED DESCRIPTION OF THE INVENTION

Hereinafter, an apparatus for treating radioactive material (radioactive waste) using a multi-membrane according to preferred embodiments of to the invention will be explained in detail referring to the attached drawings.

### First Embodiment

The apparatus 100a for treating radioactive material using a multi-membrane comprises a storage tank 101, a forward osmosis processing unit 120, a reverse osmosis processing unit 130, a temperature control unit 140, and a first membrane distillation processing unit 150.

In the embodiment, the flow of waste including radioactive waste is illustrated by dotted line arrow and the flow of treatment water is illustrated by solid line arrow.

In the embodiment, waste water containing radioactive waste is stored in the storage tank 101. Preferably, a shielding plate (not shown) for shielding radioactive waste is arranged inside the storage tank 101. An waste water inlet pipe 119 is connected to one side of the storage tank 101. A first pipe 111 connected to the forward osmosis processing unit 120 is connected to the other side of the storage tank 101.

The forward osmosis processing unit 120 is connected to the storage tank 101 and is supplied with waste water from the storage tank 101. The forward osmosis processing unit 120 supplies waste water treated with a forward osmosis process based on a density difference from draw solution to the storage tank 101. The forward osmosis processing unit 120 supplies dilution draw solution mixed with water filtered from the waste water during the forward osmosis process and the draw solution to the reverse osmosis processing unit 130. Here, the forward osmosis processing unit carries out a first dehydration, a removal of material to be processed and a reduction of load of the reverse osmosis process.

Generally, differently from the reverse osmosis processing unit 130, the forward osmosis processing unit 120 separates materials by the osmotic pressure using material, such as draw solution, which has different density from waste water. As such, solid material containing the radioactive material can be separated from waste water by the forward osmosis process in a stabilized state since an outer compression such as vapor pressure is not provided during the separation of solid material containing the radioactive material from waste water.

Various membranes for the forward osmosis process can be used. For example, the material can be CA (cellulose acetate), CTA (Cellulose triacetate), PA (Polyamid), PES (Poly ether sulfone), PAN (Polyacrylonitrile), PAA (Polyacrylic acid), PAH (Polycyclic aromatic hydrocarbon), PAI, etc. and the shape of the membrane can be a flat membrane, a hollow fiber membrane, a spiral wound type membrane, etc.

Various draw solute used for making draw solution to generate a driving force of the forward osmosis process can be used and the examples of draw solute are NaCl, KCl, MgCl₂, MgSO₄, Na₂SO₄, LaCl₃, D-glucose, NH₄HCO₃, 1,2,3-Trimethylimidazolium, PAA-Na, Magnetic nanoparticles, NH₃/CO₂.

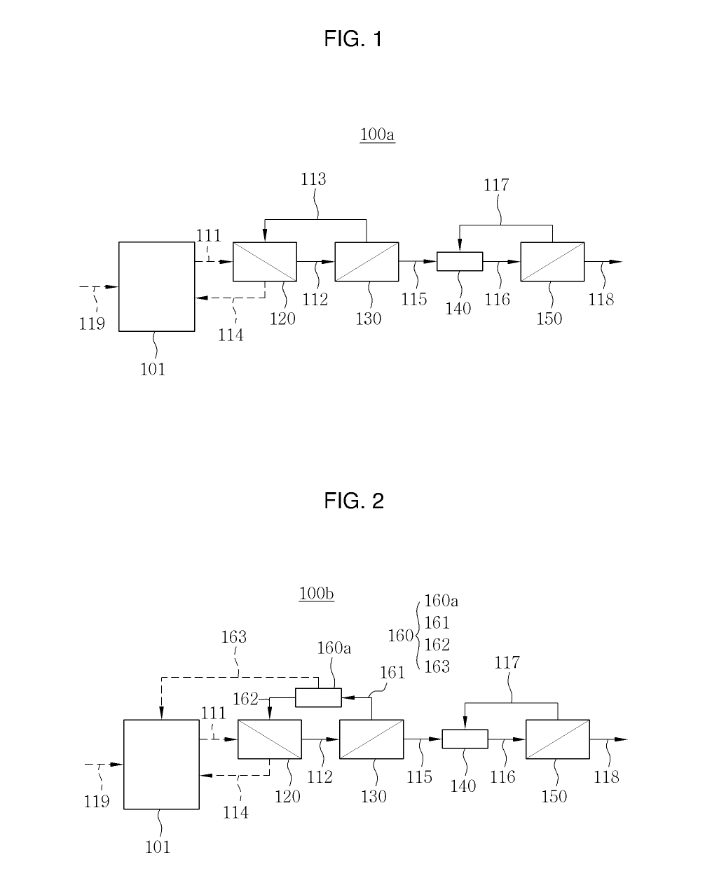

As shown in FIG. 1, a first pipe 111, a second pipe 112, a third pipe 113 and a fourth pipe 114 are connected to the forward osmosis processing unit 120. Here, the first pipe 111 connects the storage tank 101 to the forward processing unit 120. The first pipe 111 is a pathway through which waste water from the storage tank 101 is supplied to the forward osmosis processing unit 120.

The second pipe 112 connects the forward processing unit 120 to the reverse processing unit 130. The second pipe 112 is a pathway through which the dilution draw solution with which radioactive material permeated is supplied to the reverse osmosis processing unit 130 after the forward osmosis process.

The third pipe 113 connects the reverse osmosis processing unit 130 to the forward osmosis processing unit 120. Differently from the second pipe 112, the third pipe 113 is a pathway through which recovery draw solution is supplied to the forward processing unit 120 after the reverse osmosis process.

The fourth pipe 114 connects the forward osmosis processing unit 120 to the storage tank 101. The fourth pipe 114 is a pathway through which solid material is supplied to the storage tank 101. Here, solid material is a mass left when water is filtered out from waste water by the forward osmosis process of the forward osmosis processing unit 120.

In the embodiment, the first pipe 111 and the fourth pipe 114 are pathways through which waste such as waste water or radioactive material flows. The second pipe 112 is pathway through which the dilution draw solution flow. The third pipe 113 is pathway through which the recovery draw solution flow. In the embodiment, the forward osmosis processing unit 120 and the reverse osmosis processing unit 130 are connected to each other in a circulating structure by the second pipe 112 and the third pipe 113. The dilution draw solution and the recovery draw solution flow through the second pipe 112 and the third pipe 113 to perform the forward osmosis process and the reverse osmosis process.

Hereinafter, the reverse osmosis processing unit 130 will be described.

The reverse osmosis processing unit 130 is connected to the forward osmosis processing unit 120. The reverse osmosis processing unit 130 receives dilution draw solution from the forward osmosis processing unit. The dilution draw solution is formed by mixing water filtered from the waste water during the forward osmosis process and the draw solution. The reverse osmosis processing unit 130 supplies recovery draw solution to the forward osmosis processing unit. The recovery draw solution is remaining water of the dilution draw solution after treating the dilution draw solution by a reverse osmosis process. And, The reverse osmosis processing unit 130 discharges treatment water which contains water moved out from the dilution draw solution during the reverse osmosis process. That is, the reverse osmosis processing unit 130 is configured to recover the draw solution treated during the forward osmosis process and to perform a second treatment of radioactive material stably.

For membranes used for the reverse osmosis process, various materials can be used and of course, material for the membrane can be varied within the scope obvious to those skilled in the art. The operating pressure of the reverse osmosis process is intended for recovering dilution draw solution and the concentration and thus, it is preferable that the operating pressure is higher than the osmotic pressure of draw solution so as to ensure a stable amount of water permeation.

As described, the reverse osmosis processing unit 130 is connected to the forward osmosis processing unit 120 by the second pipe 112 and the third pipe 113. As shown in FIG. 1, the reverse osmosis processing unit 130 and the forward osmosis processing unit 120 are connected to each other in a circulating structure by the second pipe 112 and the third pipe 113.

As shown in FIG. 1, the reverse osmosis processing unit 130 is connected to the forward osmosis processing unit 120 by the second pipe 112. Also, the reverse osmosis processing unit 130 is connected to the forward osmosis processing unit 120 by the third pipe 113. The reverse osmosis processing unit 130 and the forward osmosis processing unit 120 have a circulating structure by means of the second pipe 112 and the third pipe 113. The draw solution is supplied from the forward osmosis processing unit 120. The reverse osmosis processing unit 130 is supplied with the draw solution from the forward osmosis processing unit 120 by the second pipe 112 and supplies the draw solution for which the reverse osmosis process is finished to the forward osmosis processing unit 120 by the third pipe 113.

A temperature control unit 140 is connected to the reverse osmosis processing unit 130 by the fifth pipe 115. After the reverse osmosis process is finished, treatment water flows from the reverse osmosis processing unit 130 into the temperature control unit 140 through the fifth pipe 115. Here, the temperature control unit 140 controls temperature of treatment water which is supplied to a membrane distillation processing unit such that temperature of treatment water from the reverse osmosis processing unit 130 can reach temperature by which a membrane distillation process can be performed.

The temperature control unit 140 is arranged between the reverse osmosis processing unit 130 and the first membrane distillation processing unit 150. The temperature control unit 140 is connected to the first membrane distillation processing unit 150 by a sixth pipe 116. Treatment water heated at the temperature control unit 140 flows into the first membrane distillation processing unit 150 in a vapor state.

In the embodiment, the first membrane distillation processing unit 150 is an apparatus configured to generate stable final treatment water by the final treating of treatment water which was generated during the reverse osmosis process. Here, the final treatment water is fluid from which radioactive material is removed and is discharged to the outside through an eighth pipe 118.

The first membrane distillation process is a process to ensure an excellent removal performance with regard to ionic material. The first membrane distillation process separates radioactive material from draw solution based on the vapor pressure difference generated by temperature difference of fluids flowing at both sides of the membrane.

Here, based on the feature of the process in which only vaporized vapor can penetrates the membrane, non-volatile material such as ionic material can be removed completely. In the embodiment, treatment water which is generated during the reverse osmosis process can be finally treated.

The membrane distillation process can be operated by a direct contact, a vacuum, an air gap, a sweep gas membrane distillation, etc. Operating temperature of water to be treated for generating a driving force can be applied at temperature higher than temperature of a cooling unit (not shown).

Membrane for the membrane distillation process may be shaped as a membrane having module of a flat membrane shape, a hollow fiber membrane shape, a tube shape, a spiral wound shape, etc. Material for membrane can be used such as PTFE (Polytetrafluoroethylene), PVDF (Polyvinylidene fluoride), PP(Polypropylene), etc. and also can be varied within the scope applicable to those skilled in the art as long as the membrane has hydrophonic properties by reforming membrane made of various other material.

In the embodiment, the first membrane distillation processing unit 150 is connected to the temperature control unit 140 in a circulating structure by the sixth pipe 116 and the seventh pipe 117. The first membrane distillation processing unit 150 repeatedly performs the first membrane distillation process until treated water which still has radioactive material becomes final treatment water which has no radioactive material.

After the first membrane distillation process, treatment water containing radioactive material returns to the temperature control unit 140 through the seventh pipe 117. Final treatment water from which radioactive material is removed is discharged to the outside through the eighth pipe 118.

Here, the seventh pipe 117 connects the first membrane distillation processing unit 150 to the temperature control unit 140. After the first membrane distillation process, treatment water flows from the first membrane distillation processing unit 150 to the temperature control unit 140 through the seventh pipe 117. Final treatment water discharged from the first membrane distillation processing unit 150 flows to the outside through the eighth pipe 118.

Process of treating waste water by an apparatus 100a for treating radioactive waste by a multi-membrane of the embodiment will be described as follows.

Waste water in the storage tank 101 flows into the forward osmosis processing unit 120 through the first pipe 111. The forward osmosis processing unit 120 separates waste water into solid material containing radioactive material and liquid water, by the forward osmosis process.

Here, solid material containing radioactive material in the forward osmosis processing unit 120 returns to the storage tank 101 through the fourth pipe 114. The draw solution used during the forward osmosis process is supplied to the reverse osmosis processing unit 130 through the second pipe 112.

The reverse osmosis processing unit 130 receives dilution draw solution from the forward osmosis processing unit. The dilution draw solution is formed by mixing water filtered from the waste water during the forward osmosis process and the draw solution. The reverse osmosis processing unit 130 supplies recovery draw solution to the forward osmosis processing unit. The recovery draw solution is remaining water of the dilution draw solution after treating the dilution draw solution by a reverse osmosis process. And, the reverse osmosis processing unit 130 discharges treatment water which contains water moved out from the dilution draw solution during the reverse osmosis process. After the reverse osmosis process is finished, the recovery draw solution in which radioactive material still exists is supplied to the forward osmosis processing unit 120 through the third pipe 113 and treatment water is supplied to the temperature control unit 140 through the fifth pipe 115.

Treatment water which flows into the temperature control unit 140 is heated to the temperature at which the first membrane distillation process can be performed. Treatment water discharged from the temperature control unit 140 flows to the first membrane distillation processing unit 150 through the sixth pipe 116. In the first membrane distillation processing unit 150, radioactive material is separated based on vapor pressure generated by the temperature difference between the membranes of the first membrane distillation processing unit 150 and therefore, treatment water becomes final treatment water. The final treatment water is treated water from which radioactive material is removed.

Here, final treatment water is discharged to the outside through the eighth pipe 118. Treatment water in which radioactive material still exists is supplied to the temperature control unit 140 through the seventh pipe 117. Here, a circulation pathway of treatment water is generated such that treatment water flows from the temperature control unit 140 to the first membrane distillation processing unit 150 through the sixth pipe 116 and then the first membrane distillation process is repeated so that the treatment water finally becomes final treatment water in which radioactive material is removed and then is discharged to the outside through the eighth pipe 118.

As such, based on the above structure and flow process, the apparatus 110a for treating radioactive material using multi-membrane repeats the forward osmosis process, the reverse osmosis process, and the membrane distillation process and therefore, waste water in the storage tank 101 can be solidified with reduced radiation, whereby increasing the waste water capacity of the storage tank 101 and enhancing the efficiency of treating radioactive material.

### Second Embodiment

Referring to FIG. 2, an apparatus for treating radioactive material using multi-membrane according to the second embodiment will be described hereinafter.

As shown in FIG. 2, the apparatus 100b for treating radioactive material using a multi-membrane comprises a storage tank 101, a forward osmosis processing unit 120, a reverse osmosis processing unit 130, a temperature control unit 140, a first membrane distillation processing unit 150, and a draw solution storage unit 160.

The storage tank 101, the forward osmosis processing unit 120, the reverse osmosis processing unit 130, the temperature control unit 140, the first membrane distillation processing unit 150 in the apparatus 100b for treating radioactive material using a multi-membrane according to the second embodiment are substantially the same as those of the first embodiment. The function of the storage tank 101, the forward osmosis processing unit 120, the reverse osmosis processing unit 130, the temperature control unit 140, the first membrane distillation processing unit 150 is substantially the same as that of the first embodiment. Therefore, in this embodiment, the detailed descriptions of the above elements are omitted and the reference number indicating the above elements will be the same as the first embodiment.

Hereinafter, the draw solution storage unit 160 which is different from the first embodiment will be explained and the connection of the draw solution storage unit 160 to the forward osmosis processing unit 120 and the reverse osmosis processing unit 130 will be described.

In this embodiment, as shown in FIG. 2, the draw solution storage unit 160 comprises a draw solution storage member 160a, a first draw solution pipe 161, a second draw solution pipe 162, and a third draw solution pipe 163.

The draw solution storage member 160a is connected to the forward osmosis processing unit 120 and the reverse osmosis processing unit 130 in a circulating structure by the first draw solution pipe 161 and the second draw solution pipe 162. The draw solution storage member 160a is connected to the storage tank 101 by the third draw solution 163.

The draw solution storage member 160a stores recovery draw solution which is supplied from the reverse osmosis processing unit 130. The recovery draw solution is generated by concentrating the dilution draw solution in the reverse osmosis processing unit. The dilution draw solution is generated by mixing water filtered from waste water during the forward osmosis process into the draw solution and the dilution draw solution also contains radioactive material which permeated with the draw solution during the forward osmosis process.

The first draw solution pipe 161 connects the reverse osmosis processing unit 130 to the draw solution storage member 160a. The recovery draw solution flows from the reverse osmosis processing unit 130 to the draw solution storage member 160a through the first draw solution pipe 161.

Then, the second draw solution pipe 162 connects the draw solution storage member 160a to the forward osmosis processing unit 120. If the recovery draw solution contained in the draw solution storage member 160a does not comprise radioactive material, the recovery draw solution in the draw solution storage member 160a is supplied to the forward osmosis processing unit 120 through the second draw solution pipe 162.

Lastly, the third draw solution pipe 163 connects the draw solution storage member 160a to the storage tank 101. Recovery draw solution in which radioactive material still exists is supplied from the draw solution storage member 160a to the storage tank 101 through the third draw solution pipe 163.

Process of treating waste water by an apparatus 100b for treating radioactive waste with a multi-membrane of the embodiment will be described as follows.

Waste water in the storage tank 101 flows into the forward osmosis processing unit 120 through the first pipe 111. The forward osmosis processing unit 120 separates waste water into solid material containing radioactive material and liquid water, by the forward osmosis process. Here, solid material containing radioactive material which was separated in the forward osmosis processing unit 120 returns to the storage tank 101 through the fourth pipe 114, and the recovery draw solution used during the forward osmosis process is supplied to the reverse osmosis processing unit 130 through the second pipe 112.

The reverse osmosis processing unit 130 receives dilution draw solution permeated with the radioactive material from the forward osmosis processing unit. The dilution draw solution is formed by mixing water filtered from the waste water during the forward osmosis process and the draw solution. After the reverse osmosis process is finished, the recovery draw solution is supplied to the draw solution storage member 160a. After the reverse osmosis process is finished, treatment water is supplied to the temperature control unit 140 through the fifth pipe 115. Here, the treatment of radioactive material which exists in the treatment water supplied to the temperature control unit 140 is the same as the first embodiment and thus, the descriptions thereof is omitted.

Meanwhile, the recovery draw solution in the draw solution storage member 160a flows depending on the existence of radioactive material and in particular, if radioactive material and waste water still exist, the recovery draw solution flows to the storage tank 101 through the third draw solution pipe 163, and if waste water not exist, the recovery draw solution flows to the forward osmosis processing unit 120 through the second draw solution pipe 162.

The apparatus 100b for treating radioactive material using a multi-membrane according to the embodiment repeats the above circulating flow, thereby reducing a dose of radioactivity of radioactive material which exists in the waste water.

Differently from the first embodiment, the apparatus 100b for treating radioactive material using a multi-membrane according to the second embodiment increases the use efficiency of draw solution which is re-used during the forward osmosis process by removing radioactive material which might have been contained in the draw solution by means of the recovery draw solution storage unit 160 once more, not by supplying the recovery draw solution to the forward osmosis processing unit 120 right after the reverse osmosis process is finished.

### Third Embodiment

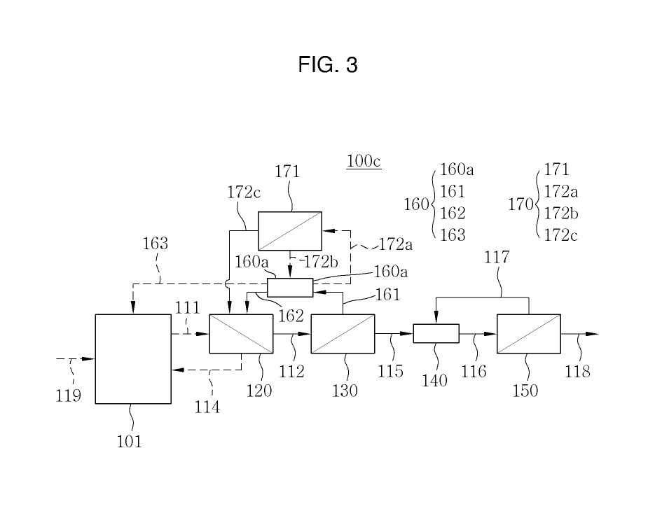

Referring to FIG. 3, an apparatus for treating radioactive material using multi-membrane according to the third embodiment will be described hereinafter.

As shown in FIG. 3, the apparatus 100c for treating radioactive material using a multi-membrane according to the embodiment comprises a storage tank 101, a forward osmosis processing unit 120, a reverse osmosis processing unit 130, a temperature control unit 140, a first membrane distillation processing unit 150, a draw solution storage unit 160, and a second membrane distillation processing unit 170.

The storage tank 101, the forward osmosis processing unit 120, the reverse osmosis processing unit 130, the temperature control unit 140, the first membrane distillation processing unit 150 in the apparatus 100c for treating radioactive material using a multi-membrane according to the third embodiment are substantially the same as those of the first embodiment. The function of the storage tank 101, the forward osmosis processing unit 120, the reverse osmosis processing unit 130, the temperature control unit 140, the first membrane distillation processing unit 150 is substantially the same as that of the first embodiment. Therefore, in this embodiment, the detailed descriptions of the above elements are omitted and the reference number indicating the above elements will be the same as the first embodiment.

Hereinafter, the draw solution storage unit 160 and the second membrane distillation processing unit 170 which are different from the first embodiment will be explained and the connection of the draw solution storage unit 160 and the second membrane distillation processing unit 170 to the forward osmosis processing unit 120 and the reverse osmosis processing unit 130 will be described.

In this embodiment, as shown in FIG. 3, the draw solution storage unit 160 comprises a draw solution storage member 160a, a first draw solution pipe 161, a second draw solution pipe 162, and a third draw solution pipe 163.

In this embodiment, the draw solution storage member 160a is connected to the forward osmosis processing unit 120, the reverse osmosis processing unit 130 and the second membrane distillation processing unit 170. In particular, the draw solution storage member 160a is connected to the forward osmosis processing unit 120 and the reverse osmosis processing unit 130 in a circulating structure by the second draw solution pipe 162 and the first draw solution pipe 161, respectively. The draw solution storage member 160a is connected to the storage tank 101 by the third draw solution pipe 163. Then, the draw solution storage member 160a is connected to the second membrane distillation member 171 by a second-A membrane distillation pipe 172a and a second-B membrane distillation pipe 172b which will be described below.

In the embodiment, the draw solution storage member 160a stores recovery draw solution which is supplied from the reverse osmosis processing unit 130. Here, the recovery draw solution is generated by concentrating the dilution draw solution in the reverse osmosis processing unit. The dilution draw solution is generated by mixing water filtered from waste water during the forward osmosis process into the draw solution and the dilution draw solution also contains radioactive material which permeated with the draw solution during the forward osmosis process.

The first draw solution pipe 161 connects the reverse osmosis processing unit 130 to the draw solution storage member 160a. Recovery draw solution flows from the reverse osmosis processing unit 130 to the draw solution storage member 160a through the first draw solution pipe 161.

Then, the second draw solution pipe 162 connects the draw solution storage member 160a to the forward osmosis processing unit 120. If the recovery draw solution contained in the draw solution storage member 160a does not comprise radioactive material, the recovery draw solution in the draw solution storage unit 160a is supplied to the forward osmosis processing unit 120 through the second draw solution pipe 162.

Lastly, the third draw solution pipe 163 connects the draw solution storage member 160a to the storage tank 101. If radioactive material exists in the recovery draw solution, the recovery draw solution in the draw solution storage member 160a is supplied to the storage tank 101 through the third draw solution pipe 163.

The second membrane distillation processing unit 170 is an apparatus to treat radioactive material which is contained in the recovery draw solution supplied to the draw solution storage 160, by the second membrane distillation process. The second membrane distillation processing unit 170 comprises a second membrane distillation member 171, a second-A membrane distillation pipe 172a, a second-B membrane distillation pipe 172b, and a second-C membrane distillation pipe 172c. The second membrane distillation processing unit 170 is arranged between the draw solution storage unit 160 and the forward osmosis processing unit 120.

In the embodiment, the second membrane distillation processing member 171 performs the second membrane distillation process to separate radioactive material contained in the recovery draw solution. The second-A membrane distillation pipe 172a, the second-B membrane distillation pipe 172b, and the second-C membrane distillation pipe 172c are connected to the second membrane distillation processing member 171.

The second-A membrane distillation pipe 172a is connected to the draw solution storage member 160a and the second membrane distillation processing member 171. The second-A membrane distillation pipe 172a is a pathway through which the recovery draw solution passes.

The second-B membrane distillation pipe 172b is connected to the draw solution storage member 160a and the second membrane distillation processing member 171. The second-B membrane distillation pipe 172b is a pathway which supplies the recovery draw solution in which radioactive material exists after the second membrane distillation process to the draw solution storage member 160a.

The second-C membrane distillation pipe 172c is connected to the second membrane distillation processing member 171 and the forward osmosis processing unit 120. The second-C membrane distillation pipe 172c is a pathway which supplies the draw solution to the forward osmosis processing unit 120 after the second membrane distillation process.

Process of treating waste water by an apparatus 100c for treating radioactive waste with a multi-membrane of the embodiment will be described as follows.

Waste water in the storage tank 101 flows into the forward osmosis processing unit 120 through the first pipe 111. The forward osmosis processing unit 120 separates waste water into solid material containing radioactive material and liquid water by the forward osmosis process. Here, solid material containing radioactive material which was separated in the forward osmosis processing unit 120 returns to the storage tank 101 through the fourth pipe 114, and the draw solution used during the forward osmosis process is supplied to the reverse osmosis processing unit 130 through the second pipe 112.

The reverse osmosis processing unit 130 receives dilution draw solution from the forward osmosis processing unit. The dilution draw solution is formed by mixing water filtered from the waste water during the forward osmosis process and the draw solution. The reverse osmosis processing unit 130 supplies recovery draw solution to the forward osmosis processing unit 120. The recovery draw solution is remaining water of the dilution draw solution after treating the dilution draw solution by a reverse osmosis process. And, the reverse osmosis processing unit 130 discharges treatment water which contains water moved out from the dilution draw solution during the reverse osmosis process. After the reverse osmosis process is finished, the recovery draw solution is supplied to the draw solution storage member 160a. After the reverse osmosis process is finished, the treatment water is supplied to the temperature control unit 140 through the fifth pipe 115. Here, the treatment of radioactive material which exists in treatment water supplied to the temperature control unit 140 is the same as the first embodiment and thus, the descriptions thereof is omitted.

Meanwhile, the recovery draw solution supplied to the draw solution storage member 160a by the first draw solution pipe 161 flows depending on the existence of radioactive material and in particular, if radioactive material and waste water still exist, the recovery draw solution flows to the storage tank 101 through the third draw solution pipe 163, and if the recovery draw solution is in a state of draw solution, it is supplied to the forward osmosis processing unit 120 through the second draw solution pipe 162.

Then, the recovery draw solution supplied to the draw solution storage member 160a flows into the second membrane distillation processing member 171 through the second-A membrane distillation pipe 172a. In the second membrane distillation processing unit 170, the second membrane distillation process which separates radioactive material from the recovery draw solution is performed. Here, the second membrane distillation process is a process which separates radioactive material contained the recovery draw solution by vapor pressure difference based on the temperature difference of fluids arranged on both sides of the membrane, like the first membrane distillation process as explained in the first embodiment.

If radioactive material is removed from the recovery draw solution by the second membrane distillation process in the second membrane distillation processing unit 170, the recovery draw solution is supplied to the forward osmosis processing unit 120 through the second-C membrane distillation pipe 172c. If radioactive material still exists, the recovery draw solution flows again to the draw solution storage unit 160 through the second-B membrane distillation pipe 172b and then flows into the second membrane distillation processing member 171 through the second-A membrane distillation pipe 172a.

Differently from the first embodiment, the apparatus 100c for treating radioactive material using a multi-membrane according to the third embodiment increases the use efficiency of draw solution which is re-used during the forward osmosis process and the efficiency of treating radioactive material as well by removing radioactive material contained in waste water which is diluted into the draw solution during the forward osmosis process by means of the second membrane distillation processing unit 170 and then supplying the draw solution not containing radioactive material to the forward osmosis processing unit 120.

### Fourth Embodiment

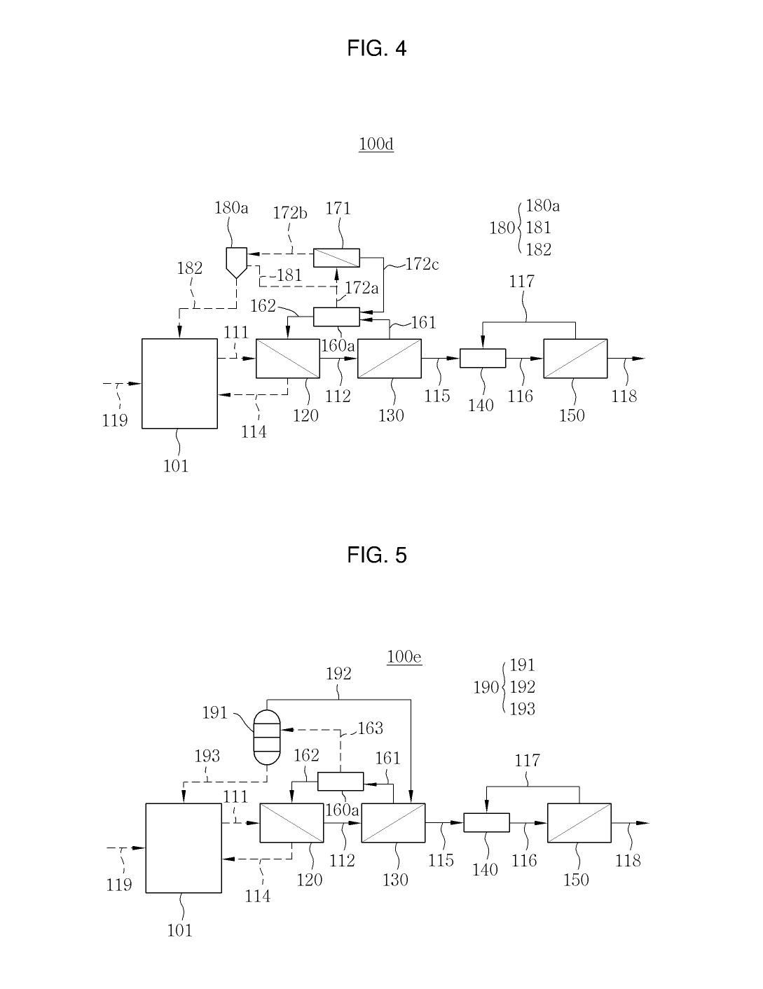

Referring to FIG. 4, an apparatus for treating radioactive material using multi-membrane according to the fourth embodiment will be described hereinafter.

As shown in FIG. 4, the apparatus 100d for treating radioactive material using a multi-membrane according to the embodiment comprises a storage tank 101, a forward osmosis processing unit 120, a reverse osmosis processing unit 130, a temperature control unit 140, a first membrane distillation processing unit 150, a draw solution storage unit 160, a second membrane distillation processing unit 170 and a crystallization unit 180.

The storage tank 101, the forward osmosis processing unit 120, the reverse osmosis processing unit 130, the temperature control unit 140, the first membrane distillation processing unit 150, and the second membrane distillation unit 170 in the apparatus 100d for treating radioactive material using a multi-membrane according to the fourth embodiment are substantially the same as those of the third embodiment. The function of the above elements of the fourth embodiment is substantially the same as that of the third embodiment. Therefore, in this embodiment, the detailed descriptions of the above elements are omitted and the reference number indicating the above elements will be the same as the third embodiment.

Hereinafter, the crystallization unit 180 which is different from the constitution disclosed in the first embodiment will be explained.

In the embodiment, the crystallization unit 180 comprises a crystallization member 180a, a first crystallization pipe 181 and a second crystallization pipe 182. The crystallization unit 180 is arranged between the second membrane distillation processing unit 170 and the storage tank 101 and is connected thereto. The crystallization unit 180 is an apparatus to crystallize recovery draw solution provided in the second membrane distillation processing unit 170 into solid phase.

In the embodiment, the crystallization member 180a is connected to the second membrane distillation processing member 171 through a second-B membrane distillation pipe 172b. The crystallization member 180a stores radioactive material which is introduced via the second-B membrane distillation pipe 172b and performs the crystallization process which crystallizes the stored radioactive material. The first crystallization pipe 181 and the second crystallization pipe 182 are connected to the crystallization member 180a.

Here, the first crystallization pipe 181 is connected to the crystallization member 180a and the second-A membrane distillation pipe 172a. Radioactive material which was not crystallized during the crystallization process is supplied to the second-A membrane distillation pipe 172a through the first crystallization pipe 181.

Further, the second crystallization pipe 182 is connected to the crystallization member 180a and the storage tank 101. Radioactive material which was crystallized during the crystallization process is supplied to the storage tank 101 through the second crystallization pipe 182.

Process of treating waste water by an apparatus 100d for treating radioactive waste with a multi-membrane of the embodiment will be described as follows.

Waste water in the storage tank 101 flows into the forward osmosis processing unit 120 through the first pipe 111. The forward osmosis processing unit 120 divides waste water into solid material containing radioactive material and liquid water by the forward osmosis process. Here, solid material containing radioactive material which was separated in the forward osmosis processing unit 120 returns to the storage tank 101 through the fourth pipe 114, and the dilution draw solution used during the forward osmosis process is supplied to the reverse osmosis processing unit 130 through the second pipe 112.

The reverse osmosis processing unit 130 receives dilution draw solution from the forward osmosis processing unit. The dilution draw solution is formed by mixing water filtered from the waste water during the forward osmosis process and the draw solution. The reverse osmosis processing unit 130 supplies recovery draw solution to the forward osmosis processing unit 120. The recovery draw solution is remaining water of the dilution draw solution after treating the dilution draw solution by a reverse osmosis process. And, the reverse osmosis processing unit 130 discharges treatment water which contains water moved out from the dilution draw solution during the reverse osmosis process. After the reverse osmosis process is finished, the recovery draw solution is supplied to the draw solution storage member 160a. After the reverse osmosis process is finished, the draw solution is supplied from the reverse osmosis processing unit 130 to the forward osmosis processing unit 120 through the third pipe 113. After the reverse osmosis process is finished, the treatment water is supplied from the reverse osmosis processing unit 130 to the temperature control unit 140 through the fifth pipe 115. Here, the treatment of radioactive material which exists in the treatment water supplied to the temperature control unit 140 is the same as the first embodiment and thus, the descriptions thereof is omitted.

Meanwhile, the recovery draw solution supplied to the draw solution storage member 160a by the first draw solution pipe 161 flows depending on the existence of radioactive material and in particular, if radioactive material and waste water still exist, the recovery draw solution flows to the storage tank 101 through the third draw solution pipe 163, and if the recovery draw solution is in a state of draw solution, it is supplied to the forward osmosis processing unit 120 through the second draw solution pipe 162.

Then, the recovery draw solution supplied to the draw solution storage member 160a flows into the second membrane distillation processing member 171 through the second-A membrane distillation pipe 172a. In the second membrane distillation processing unit 170, the second membrane distillation process which separates radioactive material from the recovery draw solution is performed. Here, the second membrane distillation process is a process which separates radioactive material contained the recovery draw solution by vapor pressure based on the temperature difference of fluids arranged on both sides of the membrane, like the first membrane distillation process as explained in the first embodiment.

In the second membrane distillation processing unit 170, if the recovery draw solution becomes in a draw solution state, it is supplied to the forward osmosis processing unit 120 through the second-C membrane distillation pipe 172c, and if there still exists radioactive material, the recovery draw solution is supplied to the crystallization member 180a through the second-B membrane distillation pipe 172b.

In the crystallization member 180a, the crystallization process which crystallizes the recovery draw solution containing radioactive material which was provided through the second-B membrane distillation pipi 172b is performed. The recovery draw solution which was not crystallized in the crystallization process flows again to the second membrane distillation processing member 171 via the first crystallization pipe 181 and the second-A membrane distillation pipe 172a.

Meanwhile, material which was crystallized in the crystallization member 180a flows into the storage tank 101 through the second crystallization pipe 182. Material supplied to the storage tank 101 and waste water contained in the storage tank 101 are supplied to the forward osmosis processing unit 120 through the first pipe 111, and this flow is repeated.

The draw solution in which radioactive material is removed by the second membrane distillation process in the second membrane distillation processing unit 170 is supplied to the forward osmosis processing unit 120 through the second-C membrane distillation pipe 172c, and the recovery draw solution in which radioactive material completely was not removed is supplied to the draw solution storage unit 160 through the second-B membrane distillation pipe 172b.

### Fifth Embodiment

Referring to FIG. 5, an apparatus for treating radioactive material using multi-membrane according to the fifth embodiment will be described hereinafter.

As shown in FIG. 5, the apparatus 100e for treating radioactive material using a multi-membrane according to the embodiment comprises a storage tank 101, a forward osmosis processing unit 120, a reverse osmosis processing unit 130, a temperature control unit 140, a first membrane distillation processing unit 150, a draw solution storage unit 160, and an evaporation unit 190.

The storage tank 101, the forward osmosis processing unit 120, the reverse osmosis processing unit 130, the temperature control unit 140, the first membrane distillation processing unit 150 in the apparatus 100e for treating radioactive material using a multi-membrane according to the fifth embodiment are substantially the same as those of the first embodiment. The function of the storage tank 101, the forward osmosis processing unit 120, the reverse osmosis processing unit 130, the temperature control unit 140, the first membrane distillation processing unit 150 is substantially the same as that of the first embodiment. Therefore, in this embodiment, the detailed descriptions of the above elements are omitted and the reference number indicating the above elements will be the same as the first embodiment.

Hereinafter, the draw solution storage unit 160 and the evaporation unit 190 which are different from the constitution disclosed in the first embodiment and the connection of the draw solution storage unit 160 and the evaporation unit 190 to the forward osmosis processing unit 120 and the reverse osmosis processing unit 130 will be explained.

As shown in FIG. 5, in the fifth embodiment, the draw solution storage unit 160 comprises a draw solution storage member 160a, a first draw solution pipe 161, a second draw solution pipe 162 and a third draw solution pipe 163.

In this embodiment, the draw solution storage member 160a is connected to the forward osmosis processing unit 120, the reverse osmosis processing unit 130 and the evaporation unit 190. The draw solution storage member 160a stores the recovery draw solution supplied from the reverse osmosis processing unit 130.

The draw solution storage member 160a is connected to the reverse osmosis processing unit 130 and the forward osmosis processing unit 120 by the first draw solution pipe 161 and the second draw solution pipe 162, respectively and is connected to the evaporation unit 190 by the third draw solution pipe 163.

The first draw solution pipe 161 connects the reverse osmosis processing unit 130 to the draw solution storage member 160a and is a path which supplies the recovery draw solution from the reverse osmosis processing unit 130 to the draw solution storage member 160a. Then, the second draw solution pipe 162 connects the draw solution storage member 160a to the forward osmosis processing unit 120 and is a path which supplies the dilution draw solution to the forward osmosis processing unit 120. The third draw solution pipe 163 is a path which connects the draw solution storage member 160a to the evaporation member 191. In this embodiment, the recovery draw solution in which radioactive material exists is supplied to the evaporation unit 190 through the third draw solution pipe 163.

By the above connection structure, the draw solution storage unit 160 has a circulating structure such that it receives the recovery draw solution which contains radioactive material after the reverse osmosis process, from the reverse osmosis processing unit 130, and then supplies the draw solution in which radioactive material in the recovery draw solution was removed, to the reverse osmosis processing unit 130 and the evaporation unit 190.

In this embodiment, the evaporation unit 190 concentrates radioactive material which exists in the recovery draw solution provided from the reverse osmosis processing unit 130 to the draw solution storage unit 160 and then supplies the concentrated radioactive material to the storage tank 101. During the concentration process, the draw solution is separated from radioactive material and then is evaporated, and the evaporation unit 190 cools the evaporated steam and then supplies the cooled draw solution to the reverse osmosis processing unit 130.

The evaporation unit 190 comprises an evaporation member 191, a first evaporation pipe 192 and a second evaporation pipe 193. The evaporation unit 190 is arranged between the draw solution storage unit 160 and the reverse osmosis processing unit 130.

In the embodiment, the evaporation member 191 performs evaporation process to separate radioactive material from the recovery draw solution. The third draw solution pipe 163, the first evaporation pipe 192 and the second evaporation pipe 193 are connected to the evaporation member 191. In the embodiment, the third draw solution pipe 163 is connected to the draw solution storage member 160a and the evaporation member 191 such that the recovery draw solution flows through the third draw solution pipe 163.

The first evaporation pipe 192 is connected to the evaporation member 191 and the reverse osmosis processing unit 130 and supplies the draw solution to the reverse osmosis processing unit 130 after the evaporation process is finished. Also, the second evaporation pipe 193 is connected to the evaporation member 191 and the storage tank 101 to supply radioactive material which was separated from the recovery draw solution after the evaporation process was finished, to the storage tank 101.

In this embodiment, the apparatus 100e for treating radioactive material using a multi-membrane according to the embodiment does not provide the draw solution directly to the forward osmosis processing unit 120 after the reverse osmosis process is finished, differently from the first embodiment as described above. Instead, the apparatus 100e removes radioactive material which may still exist in the draw solution once more by means of the draw solution storage unit 160, thereby increasing the use efficiency of draw solution which will be reused in the reverse osmosis process.

Process of treating waste water by an apparatus 100e for treating radioactive waste with a multi-membrane of the embodiment will be described as follows.

Waste water in the storage tank 101 flows into the forward osmosis processing unit 120 through the first pipe 111. The forward osmosis processing unit 120 separates waste water into solid material containing radioactive material and liquid water, by the forward osmosis process. Here, solid material containing radioactive material which was separated in the forward osmosis processing unit 120 returns to the storage tank 101 through the fourth pipe 114, and the dilution draw solution used during the forward osmosis process is supplied to the reverse osmosis processing unit 130 through the second pipe 112.

The reverse osmosis processing unit 130 receives dilution draw solution from the forward osmosis processing unit. The dilution draw solution is formed by mixing water filtered from the waste water during the forward osmosis process and the draw solution. The reverse osmosis processing unit 130 supplies recovery draw solution to the forward osmosis processing unit 120. The recovery draw solution is remaining water of the dilution draw solution after treating the dilution draw solution by a reverse osmosis process. And, the reverse osmosis processing unit 130 discharges treatment water which contains water moved out from the dilution draw solution during the reverse osmosis process. After the reverse osmosis process is finished, the recovery draw solution is supplied to the draw solution storage member 160a, and the treatment water is supplied to the temperature control unit 140 through the fifth pipe 115. Here, the treatment of radioactive material which exists in the treatment water supplied to the temperature control unit 140 through the fifth pipe 115 is the same as the first embodiment and thus, the descriptions thereof is omitted.

Meanwhile, the recovery draw solution which is introduced into the draw solution storage member 160a through the first draw solution pipe 161 flows depending on the existence of radioactive material in such a manner that if the recovery draw solution contains radioactive material and waste water, it is supplied to the evaporation member 191 through the third draw solution pipe 163, and if the recovery draw solution contains no radioactive material, the recovery draw solution is supplied to the forward osmosis processing unit 120 through the second draw solution pipe 162.

The evaporation member 191 performs evaporation process. By the evaporation process in the evaporation member 191, draw solution containing no radioactive material is supplied to the reverse osmosis processing unit 130 and the draw solution in which radioactive material is not removed completely is supplied to the storage tank 101 through the second evaporation pipe 193.

Differently from the first embodiment as described above, the apparatus 100e for treating radioactive material using a multi-membrane according to the embodiment does not provide the draw solution directly to the forward osmosis processing unit 120 after the reverse osmosis process is finished. But, instead, the apparatus 100e removes radioactive material which may still exist in the draw solution once more by means of the draw solution storage unit 160, and then supplies the recovery draw solution containing radioactive material which was not removed by the draw solution storage unit 160, to the evaporation unit 190 so as to purify the recovery draw solution, thereby increasing the use efficiency of draw solution which will be reused in the reverse osmosis process.

### Sixth Embodiment

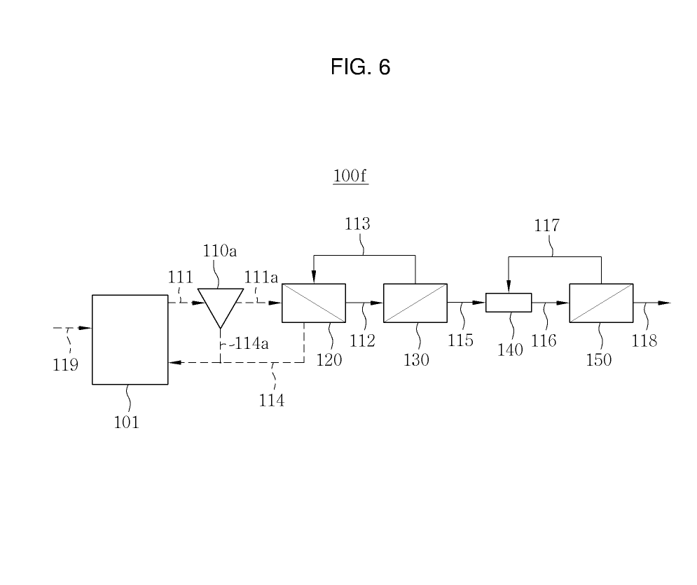

Referring to FIG. 6, an apparatus for treating radioactive material using multi-membrane according to the sixth embodiment will be described hereinafter.

As shown in FIG. 6, the apparatus 100f for treating radioactive material using a multi-membrane according to the embodiment comprises a storage tank 101, a forward osmosis processing unit 120, a reverse osmosis processing unit 130, a temperature control unit 140, a first membrane distillation processing unit 150, and a pretreatment unit 110a.

The storage tank 101, the forward osmosis processing unit 120, the reverse osmosis processing unit 130, the temperature control unit 140, the first membrane distillation processing unit 150 in the apparatus 100f for treating radioactive material using a multi-membrane according to the sixth embodiment are substantially the same as those of the first embodiment. The function of the storage tank 101, the forward osmosis processing unit 120, the reverse osmosis processing unit 130, the temperature control unit 140, the first membrane distillation processing unit 150 is substantially the same as that of the first embodiment. Therefore, in this embodiment, the detailed descriptions of the above elements are omitted and the reference number indicating the above elements will be the same as the first embodiment.

Hereinafter, the pretreatment unit 110a which is different from the first embodiment as described above and the connection of the pretreatment unit 110a to the storage tank 101 and the forward osmosis processing unit 120 will be described.

As shown in FIG. 6, the pretreatment unit 110a is arranged between the storage tank 101 and the forward osmosis processing unit 120. In this embodiment, a first pipe 111 and a forth pipe 114 is connected to the pretreatment unit 110a. The pretreatment unit 110a is an apparatus which is used for pretreatment of the forward osmosis process and it removes solid material such as suspended solid contained waste water when waste water is being supplied from the storage tank 101 to the forward osmosis processing unit 120.

In this embodiment, a first pipe 111 connecting the storage tank 101 to the pretreatment unit 110a, a first-A pipe 111a connecting the pretreatment unit 110a to the forward osmosis processing unit 120, and a fourth-A pipe 114a connecting the pretreatment unit 110a to the fourth pipe 114 are connected to the pretreatment unit 110a.

The pretreatment process is performed as follows. First, waste water discharged from the storage tank 101 through the pipe 111 flows into the pretreatment unit 110a. In the pretreatment unit 110a, solid material is separated from waste water and then liquid waste water flows into the forward osmosis processing unit 120 through the first-A pipe 111a. Then, the solid material which was separated in the pretreatment unit 110a flows into the fourth pipe 114 via the fourth-A pipe 114a and then returns to the storage tank 101.

Meanwhile, waste water introduced into the forward osmosis processing unit 120, flows through the forward osmosis processing unit 120, the reverse osmosis processing unit 130, the temperature control unit 140 and the first membrane distillation processing unit 150, sequentially to separate radioactive material contained in the waste water, thereby forming circulation path, as described in the first embodiment.

The apparatus 100f for treating radioactive material using a multi-membrane performs repeatedly the pretreatment process, the forward osmosis process, the reverse osmosis process and the membrane distillation process such that the waste water in the storage tank 101 is solidified with reduced radiation, thereby increasing the capacity to contain waste water and increasing the efficiency of treating radioactive material.

It is obvious for those skilled in the art that the invention explained above is not limited to the embodiment described above and attached drawings and can be replaced, modified and changed within the scope which does not depart from the essential technical spirit of the invention.

[Reference number]

100a, 100b, 100c, 100d, 100e, 100f: apparatus for treating radioactive
material apparatus for treating radioactive material using a
multi-membrane

| | |
|---|---|
| 101: storage tank | 110a: pretreatment unit |
| 111: first pipe | 111a: first-A pipe |
| 112: second pipe | 113: third pipe |
| 114: fourth pipe | 114a: fourth-A pipe |
| 115: fifth pipe | 116: sixth pipe |
| 117: seventh pipe | 118: eighth pipe |
| 119: waste water inlet pipe | 120: forward osmosis processing unit |
| 130: reverse osmosis processing | 140: temperature control unit |
| unit | |

150: first membrane distillation processing unit

| | |
|---|---|
| 160: draw solution storage | 160a: draw solution storage member |
| unit | |
| 161: first draw solution pipe | 162: second draw solution pipe |
| 163: third draw solution pipe | |

170: second membrane distillation processing unit
171: second membrane distillation processing member
172a: second-A membrane distillation pipe
172b: second-B membrane distillation pipe
172c: second-C membrane distillation pipe

| | |
|---|---|
| 180: crystallization unit | 180a: crystallization member |
| 181: first crystallization pipe | 182: second crystallization pipe |
| 190: evaporation unit | 191: evaporation member |
| 192: first evaporation pipe | 193: second evaporation pipe |

1. An apparatus for treating radioactive material apparatus using a multi-membrane comprising:
a storage tank which stores waste water containing radioactive material;
a forward osmosis processing unit which is connected to the storage tank to receive waste water from the storage tank, and which supplies waste water treated by a forward osmosis process based on a density difference from draw solution to the storage tank; and
a reverse osmosis processing unit which is connected to the forward osmosis processing unit to receive dilution draw solution from the forward osmosis processing unit, the dilution draw solution being formed by mixing water filtered from the waste water during the forward osmosis process and the draw solution, which supplies recovery draw solution to the forward osmosis processing unit, the recovery draw solution being remaining water of the dilution draw solution after treating the dilution draw solution by a reverse osmosis process, and which discharges treatment water which contains water moved out from the dilution draw solution during the reverse osmosis process.

2. The apparatus according to claim 1, further comprising a first membrane distillation processing unit which is connected to the reverse osmosis processing unit to receive the treatment water from the reverse osmosis processing unit and which generates final treatment water by treating radioactive material which still exists in the treatment water, by a first membrane distillation process.

3. The apparatus according to claim 2, further comprising a temperature control unit connected to the reverse osmosis processing unit and the first membrane distillation processing unit, the temperature control unit being configured to control temperature of the treatment water such that the temperature of the treatment water supplied from the reverse osmosis processing unit to the first membrane distillation processing unit becomes a temperature at which the first membrane distillation process is performed,
wherein the temperature control unit is connected to the first membrane distillation processing unit in a circulation structure to receive the treatment water containing radioactive material from the first membrane distillation processing unit.

4. The apparatus according to claim 1, wherein a draw solution storage unit which stores the recovery draw solution is connected to the forward osmosis processing unit and the reverse osmosis processing unit to form a circular structure, the recovery draw solution is stored in the draw solution storage unit and then is supplied to the forward osmosis processing unit.

5. The apparatus according to claim 4, further comprising a second membrane distillation processing unit which is arranged between the draw solution storage unit and the forward osmosis processing unit, wherein the second membrane distillation processing unit generates draw solution by treating the radioactive material which exists in the recovery draw solution stored in the draw solution storage unit by a second membrane distillation process based on a vapor pressure difference.

6. The apparatus according to claim 5, further comprising a crystallization unit connected to the second membrane distillation processing unit and the storage tank, wherein the crystallization unit receives the recovery draw solution in which radioactive material still exits after the second membrane distillation process and then crystallizes the recovery draw solution.

7. The apparatus according to claim 4, further comprising an evaporation unit connected to the draw solution storage unit and the storage tank, wherein the evaporation unit receives the recovery draw solution containing radioactive material from the draw solution storage unit, separates the recovery draw solution into radioactive material and draw solution by an evaporation process, and then supplies the separated radioactive material to the storage tank and supplies the separated draw solution to the reverse osmosis processing unit.

8. The apparatus according to claim 1, further comprising a pretreatment unit connected to the storage tank and the forward osmosis processing unit, wherein the pretreatment unit separates solid material from the waste water before the waste water in the storage tank flows into the forward osmosis processing unit, and then supplies the solid material to the storage tank and supplies waste water in which the solid material was separated to the forward osmosis processing unit.
